(19) United States
(12) Patent Application Publication
(10) Pub. No.: US 2009/0300905 A1
(43) Pub. Date: Dec. 10, 2009

(54) FIXING DEVICE

(75) Inventor: TAI-HSU CHOU, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/330,569

(22) Filed: Dec. 9, 2008

(30) Foreign Application Priority Data
Jun. 10, 2008 (CN) 200810302083.4

(51) Int. Cl. H02K 15/00

(52) U.S. Cl. 29/732

(57) ABSTRACT

A fixing device for a voice coil motor component includes a first clamp, a second clamp and a connecting element. The first clamp has a first surface which defines a first recess. The second clamp has a second surface which defines a second recess. The connecting element engages the first clamp and the second clamp to fix the voice coil motor component between the first clamp and the second clamp.

### BACKGROUND

1. Technical Field

The invention relates to fixing devices and, more particularly, to a fixing device for a voice coil motor component.

2. Description of Related Art

As disclosed in “A New High-speed Accurate Fixed Position System Design Method of a Voice Coil Electric Machinery” (China Mechanical Engineering, 16(16):1414-1419, 2005), a voice coil motor (VCM) is a new direct drive electric machinery utilizing ampere force technology. The VCM differs from linear electric machinery in its ability to avoid gaps when transmission links driving the rotating electric machinery are insufficient, and features increased speed, reduced volume, and more convenient control. Accordingly the VCM is in widespread use in devices such as cell phone camera modules.

On the other hand, the reduced volume of the VCM creates difficulty in fixing two elastic members on a frame by adhesive in the assembly process. When the elastic members are pressed to dispense adhesive by finger, the elastic members and the frame are too small to be fixed, and the elastic members are easily warped.

### BRIEF DESCRIPTION OF THE DRAWINGS

FIG. 1 is an exploded, isometric view of a fixing device, in accordance with a first embodiment.

FIG. 2 is similar to FIG. 1, but viewed from a different perspective.

FIG. 3 is an isometric view an assembly of a voice coil motor, in accordance with the first embodiment.

FIG. 4 is an exploded view of the assembly of the voice coil motor of FIG. 3.

FIG. 5 is a first work state schematic, isometric view of the fixing device of FIG. 1.

FIG. 6 is a second work state schematic, isometric view of the fixing device of FIG. 1.

FIG. 7 is an exploded, isometric view of a fixing device in accordance with a second embodiment.

FIG. 8 is an exploded, isometric view of a fixing device, in accordance with a third embodiment.

FIG. 9 is similar to FIG. 8, but viewed from a different perspective.

### DETAILED DESCRIPTION

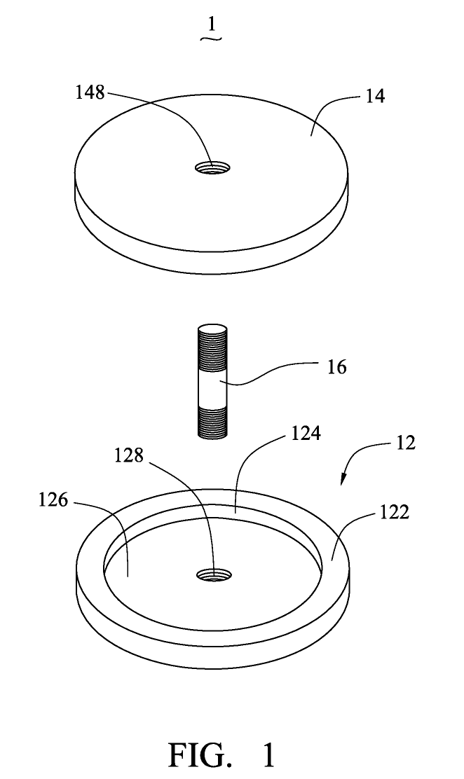

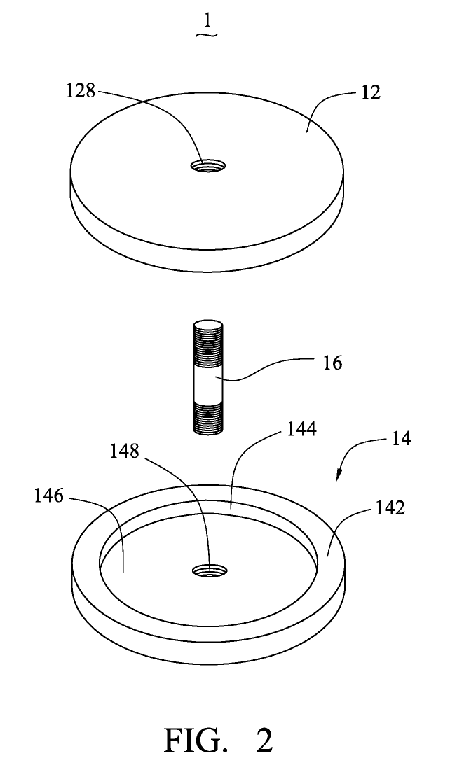

Referring to FIGS. 1 and 2, a fixing device 1 according to a first embodiment of the disclosure is shown. The fixing device 1 includes a first clamp 12 connected to a second clamp 14 by a connecting element 16.

The first clamp 12 includes a first surface 122 which defines a first recess 124. The first recess 124 has a first bottom face 126, the center of which defines a first through screw hole 128. The first recess 124 can be, for example, circular.

The second clamp 14 includes a first surface 142 which defines a second recess 144. The second recess 144 has a second bottom face 146, the center of which defines a second through screw hole 148. The second recess 144 can be, for example, circular.

The connecting element 16 is a threaded post, two ends of which define threads and engage the first screw hole 128 of the first clamp 12 and the second screw hole 148 of the second clamp 14 to connect the first clamp 12 and the second clamp 14.

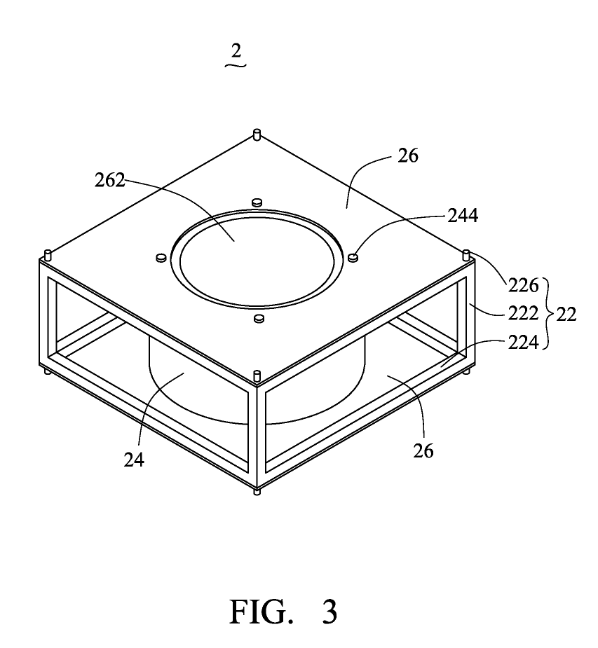

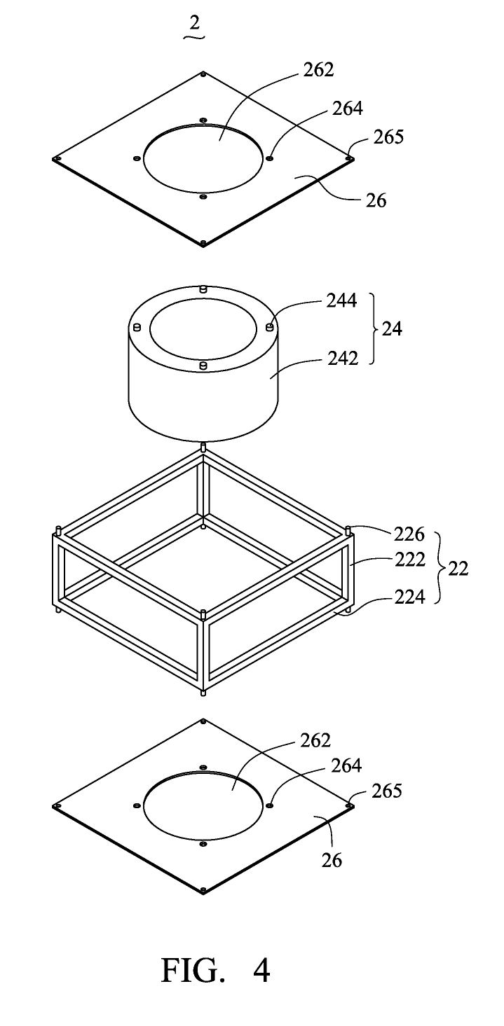

Referring to FIGS. 3 and 4, a voice coil motor component 2 includes a frame 22, a camera carry base 24, and two elastic members 26. The frame 22 includes four parallel support pillars 222 and a plurality of horizontal bars 224, each of which connects the parallel support pillars 222. Two ends of each of the support pillars 222 have a first fixed pillar 226, respectively. The camera carry base 24, disposed in the frame 22, includes a tube 242, two ends of which have four second fixed pillars 244, respectively. Each elastic member 26, disposed on the frame 22 and two ends of the tube 242, defines a first hole 262 which is disposed in the center of the elastic member 26, and defines a second hole 264 and a third hole 265, both of which correspond to one of the second fixed pillars 244 and one of the first fixed pillars 226, respectively. For example, each of the elastic member 26 can define four second holes 264 and four third holes 265. The first fixed pillars 226 and the second fixed pillars 244 are disposed through the third holes 265 and the second holes 264 to fix two the elastic members 26.

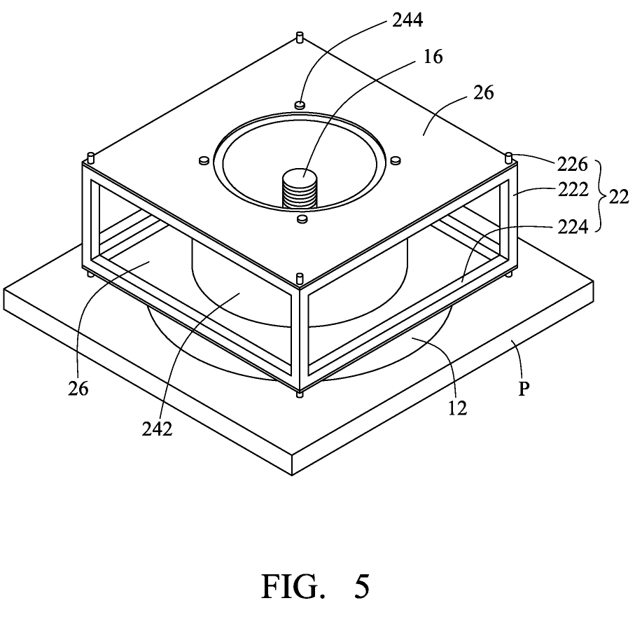

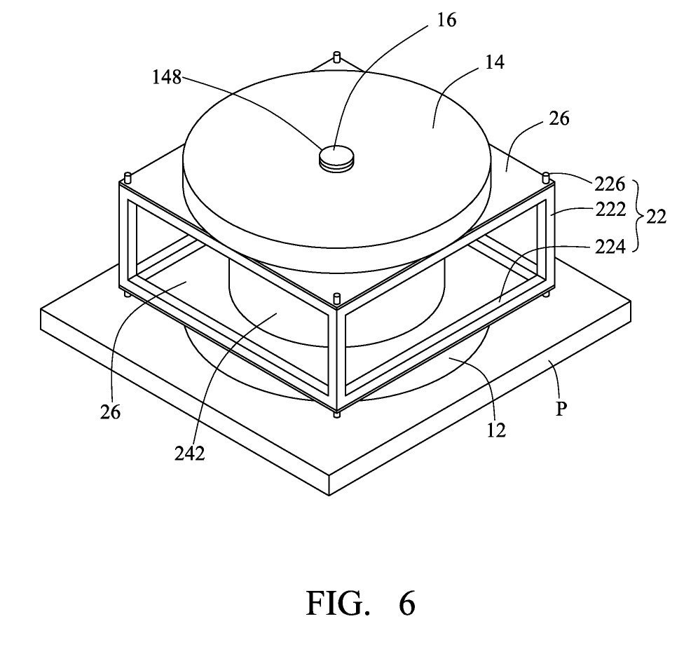

Referring to FIGS. 4 to 6, when the fixing device 1 is assembled to the voice coil motor component 2, the first clamp 12 is placed on a work platform P with the first surface 122 facing upward. The elastic members 26, the frame 22 and the camera carry base 24 are disposed on the first clamp 12 in turn. The camera carry base 24 is disposed in the frame 22, and the elastic members 26 are disposed on two ends of the frame 22, respectively. In addition, the first fixed pillars 226 and the second fixed pillar 244 are disposed through each of the corresponding second holes 264 and each of the corresponding third holes 265 of the elastic members 26, respectively. The connecting element 16 is disposed through the elastic members 26 and the camera carry base 24. Two ends of the connecting element 16 engage the first screw hole 128 of the first clamp 12 and the second screw hole 148 of the second clamp 14, respectively, tightly connecting the first surface 122 of the first clamp 12 and the second surface 142 of the second clamp 14 on the elastic members 26 and fixing the voice coil motor component 2. Adhesive is dispensed between at least one connecting position of each of the four of the horizontal bars 224 and the elastic member 26 to fix the elastic members 26 on the frame 22. The first clamp 12, the second clamp 14, and the connecting element 16 are removed from the voice coil motor component 2, and the assembly of the voice coil motor component 2 is complete.

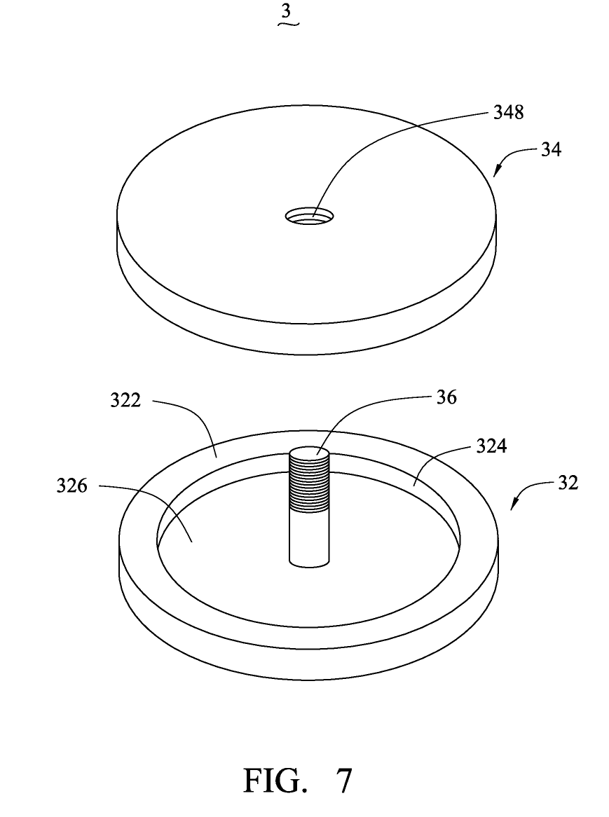

Referring to FIG. 7, a fixing device 3 according to a second embodiment of the disclosure is shown, differing from the first embodiment only in that one end of the connecting element 36 is fixed to the first bottom face 326 of the first clamp 32 by integral formation, interference fit, or other fixing method. The other end of the connecting element 36 engages the second clamp 34.

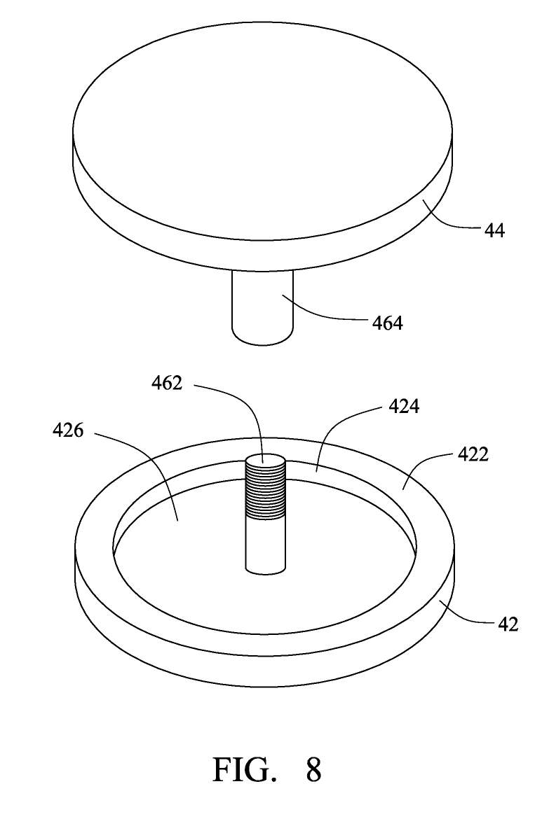

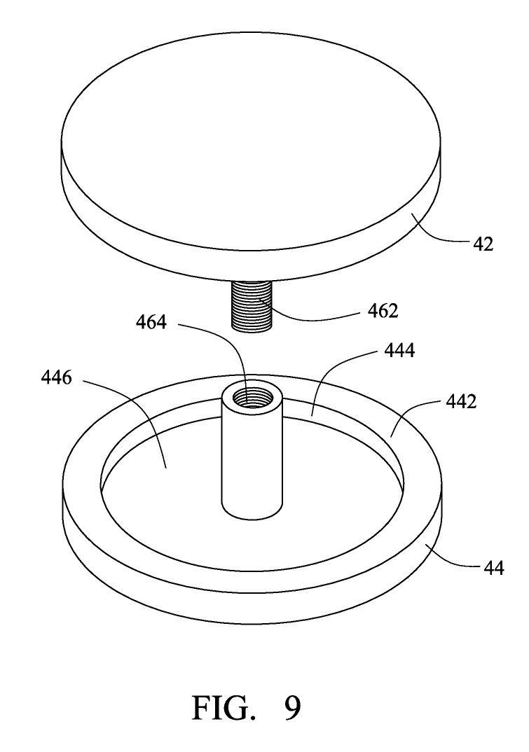

Referring to FIGS. 8 and 9, a fixing device 4 according to a third embodiment of the disclosure is shown, differing from the fixing device 4 and the fixing device 1 of the first embodiment only in that the connecting element 46 includes a first connecting portion 462 and a second connecting portion 464 corresponding thereto. The first connecting portion 462 is a threaded post defining a thread, and one end of the first connecting portion 462 is fixed to the center of the first bottom 426 of the first clamp 42. The second connecting portion 464 is a circular pillar defining a screw hole therein, and one end of the second connecting portion 464 is fixed to the center of the second bottom 446 of the second clamp 44. The first connecting portion 462 engages the second connecting portion 464 to connect the first clamp 42 and second clamp 44.

The disclosed fixing device fixes the voice coil motor component by the connecting element connecting with the first clamp and the second clamp to tightly and levelly join two elastic members on the frame with simplified assembly.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fixing device for a voice coil motor component, comprising:
a first clamp comprising a first surface defining a first recess;
a second clamp comprising a second surface defining a second recess; and
a connecting element;
wherein the connecting element connects with the first clamp and the second clamp to fix the voice coil motor component between the first clamp and the second clamp.

2. The fixing device as claimed in claim 1, wherein the first recess of the first clamp comprises a first bottom face defining a first screw hole, and the second recess of the second clamp comprises a second bottom face defining a second screw hole through to the second clamp, and two ends of the connecting element define threads and engage the first screw hole and the second screw hole, respectively.

3. The fixing device as claimed in claim 1, wherein the first recess of the first clamp comprises a first bottom face, on which one end of the connecting element is fixed, and the second recess of the second clamp comprises a second bottom face defining a second screw hole, into which the other end of the connecting element is capable of engaging.

4. The fixing device as claimed in claim 3, wherein the connecting element is integrally formed with the first clamp.

5. The fixing device as claimed in claim 1, wherein the first recess of the first clamp comprises a first bottom face, the second recess of the second clamp comprises a second bottom face, and the connecting element comprises a first connecting portion and a second connecting portion corresponding to the first connecting portion, the first connecting portion is fixed on the first bottom face of the first recess, the second connecting portion is fixed on the second bottom face of the second recess, and the first connecting portion is capable of connecting with the second connecting portion.

6. The fixing device as claimed in claim 5, wherein the first connecting portion is a threaded post defining a thread, and the second connecting portion is a circular pillar defining a screw hole corresponding to the threaded post.

7. The fixing device as claimed in claim 5, wherein the first connecting portion is integrally formed with the first clamp, and the second connecting portion is integrally formed with the second clamp.

8. A fixing device for a voice coil motor component, comprising:
a first clamp comprising a first surface defining a first recess, the first recess comprising a first bottom face;
a second clamp comprising a second surface defining a second recess, the second recess comprising a second bottom face; and
a connecting element fixed on the first bottom face;
wherein the connecting element is capable of engaging the second bottom face of the second recess to fix the voice coil motor component between the first clamp and the second clamp.

9. The fixing device as claimed in claim 8, the second bottom face defining a second screw hole, the connecting element defines a thread on a distal end thereof, and the threaded end of the connecting element is capable of engaging the second screw hole.

10. The fixing device as claimed in claim 8, wherein the connecting element is integrally formed with the first clamp.

11. A fixing device for a voice coil motor component, comprising:
a first clamp comprising a first surface defining a first recess, the first recess comprising a first bottom face;
a second clamp comprising a second surface defining a second recess, the second recess comprising a second bottom face; and
a connecting element comprising a first connecting portion and a second connecting portion corresponding to the first connecting portion, the first connecting portion fixed on the first bottom face of the first recess, and the second connecting portion fixed on the second bottom face of the second recess;
wherein the first connecting portion is capable of engaging the second connecting portion to fix the voice coil motor component between the first clamp and the second clamp.

12. The fixing device as claimed in claim 11, wherein the first connecting portion is a threaded post defining a thread, and the second connecting portion is a circular pillar defining a screw hole corresponding to the threaded post.

13. The fixing device as claimed in claim 11, wherein the first connecting portion is integrally formed with the first clamp, and the second connecting portion is integrally formed with the second clamp.
